(19) United States
(12) Patent Application Publication
(10) Pub. No.: US 2009/0173844 A1
(43) Pub. Date: Jul. 9, 2009

(54) CONDUIT AND CABLE SUPPORT BRACKET AND METHOD THEREFOR

(76) Inventor: Weixiong Huo, Las Vegas, NV (US)

Correspondence Address: WEISS & MOY PC, 4204 NORTH BROWN AVENUE, SCOTTSDALE, AZ, 85251, US

(21) Appl. No.: 12/368,383

(22) Filed: Feb. 10, 2009

Related U.S. Application Data
(63) Continuation-in-part of application No. 11/888,636, filed on Aug. 2, 2007.

(51) Int. Cl. F16L 3/08; A47B 96/06

(52) U.S. Cl. 248/65; 248/300

(57) ABSTRACT

A support bracket has a first support plate having a cut-out formed therein. A second support plate extends from a top surface of the first support plate. The second support plate is approximately perpendicular to the first support plate. A second support plate connector opening is formed through the second support plate. An “L” shape plate extends down from second support plate wherein a bottom leg of the “L” shape plate is approximately parallel with the second support plate.

### RELATED APPLICATIONS

The present application is a Continuation-In-Part of U.S. patent application Ser. No. 11/888,636, filed Aug. 2, 2007, entitled, “SPIDER” BRACKET”, in the name of the same inventor, and is hereby incorporated herewith.

### FIELD OF THE INVENTION

The present invention relates to electrical cables, conduits the like, and more specifically, to a support bracket for electrical cables and conduits.

### BACKGROUND OF THE INVENTION

In the construction industry, electrical conduit may be used to effectively and safely deliver electricity to different areas of a building. The electrical conduit may be run above ground of underground for connection with electrical installations located inside and outside of buildings, and particularly for connection to aboveground electrical boxes. Installation in which electrical conduit is connected to electrical boxes requires that the conduit be integrated and spatially-positioned in accordance to industry standards for electrical conduit installation.

Presently, straps, harnesses, spacers, and supports have been devised to hold electrical conduits and cables. Most advancement in this area have come by way of using new materials with fewer complicated or different parts. Because the space taken by these devices may account for some space that could be occupied by mechanical load bearing structures, it is desired that these devices be not obstructive, unduly large, or unwieldy. It would be advantageous to have them made of a single piece of material, because holding devices made of several pieces might tend to separate under pressure, stress, or strain.

Therefore, a need exists to provide a device and method to overcome the above problem of the prior art. The device and method need to support electrical cables and conduits. The device and method need to support electrical cables and conduits while being unobstructive, unduly large, or unwieldy. The device and method may be made of a single piece of material so as to not separate under pressure, stress, or strain.

### SUMMARY

In accordance with one embodiment, a support bracket is disclosed. The support bracket has a first support plate having a cut-out formed therein. A second support plate extends from a top surface of the first support plate. The second support plate is approximately perpendicular to the first support plate. A second support plate connector opening is formed through the second support plate. An “L” shape plate extends down from second support plate wherein a bottom leg of the “L” shape plate is approximately parallel with the second support plate.

In accordance with another embodiment of the present invention, a support bracket is disclosed. The support bracket has a first support plate. A cut-out is formed in the first support plate. A second support plate extends from a top surface of the first support plate. The second support plate is approximately perpendicular to the first support plate. A second support plate connector opening is formed through the second support plate. An “L” shape plate extends down from the second support plate. A bottom leg of the “L” shape plate is approximately parallel with the second support plate. A plurality of bottom leg connector holes formed in the bottom leg of the “L” shape plate. The bottom leg of the “L” shaped plate is approximately planer with a top of the cut-out.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is an elevated perspective view of one embodiment of the support bracket;

FIG. 2 is a perspective view of the support bracket of FIG. 1 in use;

FIG. 3 is an exploded perspective view of the support bracket shown in FIG. 2; and

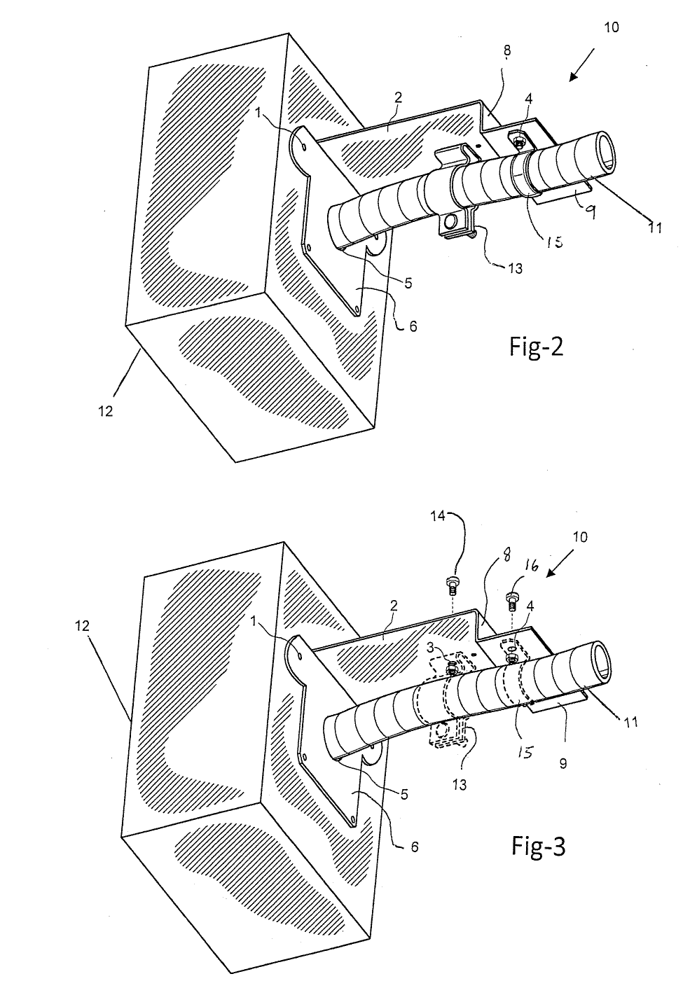

FIG. 2 is an elevated perspective view of another embodiment of the support bracket.

### DETAILED DESCRIPTION

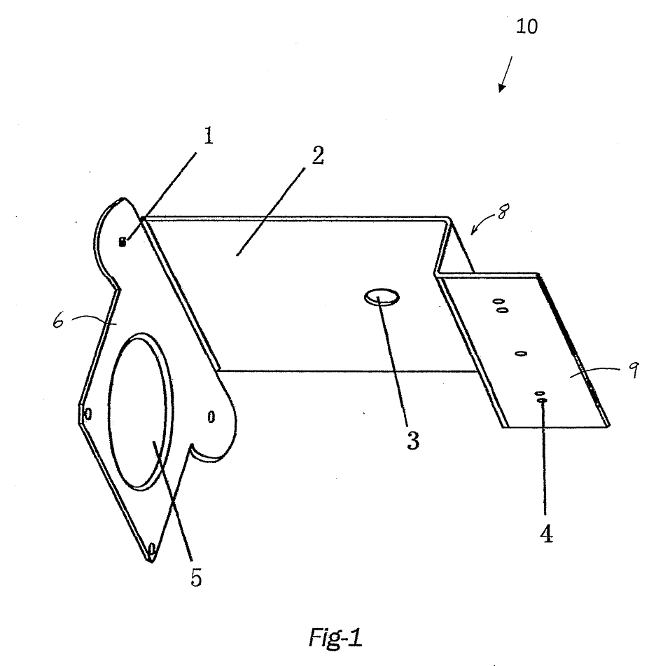

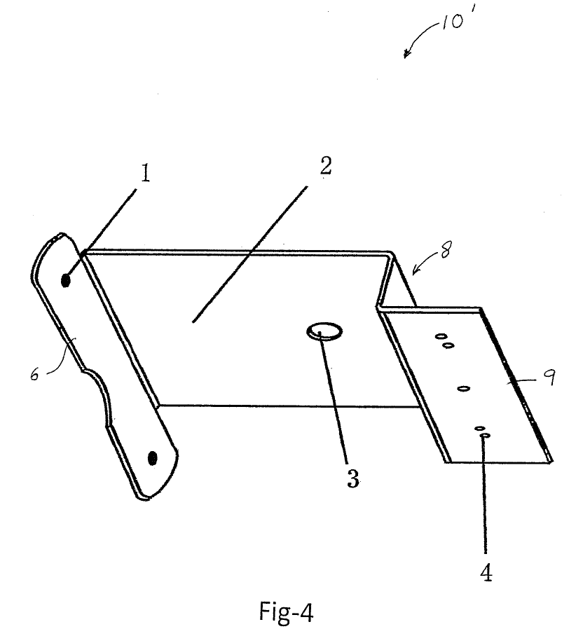

Referring to FIGS. 1-3, a support bracket 10 is shown. The support bracket 10 is used to support electrical conduit and or electrical cables 11 (hereinafter conduit 11) being strapped by mini-straps, one-hole straps, and the like.

The support bracket 10 has a first plate member 6. The first plate member 6 may be attached to a cable tray, junction box, electrical panel, electrical enclosures, or the like (hereinafter enclosure 12). The above listing is given as an example and should not be seen as to limit the scope of the present invention. The plate 6 has a plurality of openings 1 formed around a perimeter of the first plate member 6. The openings 1 may be used to secure the first plate member 6 to the enclosure 12. In generally, the first plate member 6 may be position and abuts against the enclosure 12. A connector is then positioned through the openings 1 to secure the first plate member 6 to the enclosure 12. The connector may be a screw or other type of connector.

An opening 5 may be formed through the first plate member 6. The opening 5 is generally formed through a central area of the first plate member 6. The opening 5 may be sized to approximately match the size of the conduit 11 the support bracket 10 is supporting. The opening 5 may also be used to secure the support bracket 10 to the enclosure 12. In general, an electrical coupling may be used to secure the support bracket 10 to the enclosure 12.

In general, the first plate member 6 may be rectangular is shape. As shown in FIG. 1, the first plate member 6 may have a top section which extends slightly outward to form a “T” shape first plate member 6. The above are given as examples. The first plate member 6 may take on other shapes without departing from the spirit and scope of the present invention.

A second plate member 2 extends away from a top section of the first plate member 6. The second plate member 2 may be approximately perpendicular to the first plate member 6. The second plate member 2 may have an opening 3 formed there-through. The opening 3 may be used to secure a mini-strap 13 or other type of support strap to the second plate member 2. The mini-strap 13 and or other type of support strap may be used to support the electrical conduit/cable positioned through the opening 5. In general, a connector 14 is positioned through the openings 5 to secure the mini-strap 13 and or other type of support strap to the second plate member 2.

An “L” shape plate member 8 extends down from an edge of the second plate member 7 so that a bottom leg 9 of the “L” shape plate member 8 is approximately parallel with the from second plate member 7. In accordance with one embodiment, the bottom leg 9 of the “L” shape plate member 8 is approximately planer with a top of the opening 5.

The bottom leg 9 of the “L” shape plate member 8 will have a plurality of holes 4 formed there-through. The openings 4 may be used to secure a one-hole strap 15 or other type of support strap to the bottom leg 9 of the “L” shape plate member 8. The one-hole strap 15 and or other type of support strap may be used to support the electrical conduit/cable positioned through the opening 5. In general, a connector 16 is positioned through the openings 5 to secure the one-hole strap or other type of support strap to the second plate member 7.

Referring to the FIG. 4, a support bracket 10′ is shown. The support bracket 10′ is used to support electrical conduit and or electrical cables being strapped by mini-straps, one-hole straps, and the like.

The support bracket 10 has a first plate member 6. The first plate member 6 may be attached to a cable tray, junction box, electrical panel, electrical enclosure, or the like. The above listing is given as an example and should not be seen as to limit the scope of the present invention. The plate 6 has a plurality of openings 1 formed around the outer edges of the first plate member 6. The openings 1 may be used to secure the first plate member 6 to the cable tray, junction box, electrical panel, or the like. In generally, the first plate member 6 may be position and abuts against the cable tray, junction box, electrical panel, or the like. A connector is then positioned through the openings 1 to secure the first plate member 6 to the cable tray, junction box, electrical panel, or the like. The connector may be a screw or other type of connector.

A semi-circular cut-out 11 may be formed through a bottom edge of the first plate member 6. The cut-out 11 may be sized to approximately match the curvature of the electrical conduit/cable the support bracket 10′ is supporting. The cut-out 11 may also be used to secure the support bracket 10′ to the cable tray, junction box, electrical panel, or the like. In general, an electrical coupling may be used to secure the support bracket 10 to the cable tray, junction box, electrical panel, or the like.

In general, the first plate member 6 may be rectangular is shape. However, the first plate member 6 may take on other shapes without departing from the spirit and scope of the present invention.

A second plate member 7 extends away from a top section of the first plate member 6. The second plate member 7 may be approximately perpendicular to the first plate member 6. The second plate member 7 may have an opening 3 formed there-through. The opening 3 may be used to secure a mini-strap or other type of support strap to the second plate member 7. The mini-strap and or other type of support strap may be used to support the electrical conduit/cable positioned through the opening 5. In general, a connector is positioned through the openings 5 to secure the mini-strap and or other type of support strap to the second plate member 7.

An “L” shape plate member 8 extends down from second plate member 7 so that a bottom leg 9 of the “L” shape plate member 8 is approximately parallel with the from second plate member 7. In accordance with one embodiment, the bottom leg 9 of the “L” shape plate member 8 is approximately planer with a top of the cut-out 11.

The bottom leg 9 of the “L” shape plate member 8 will have a plurality of holes 4 formed there-through. The openings 4 may be used to secure a one-hole strap or other type of support strap to the bottom leg 9 of the “L” shape plate member 8. The one-hole strap and or other type of support strap may be used to support the electrical conduit/cable positioned through the opening 5. In general, a connector is positioned through the openings 5 to secure the one-hole strap or other type of support strap to the second plate member 7.

While embodiments of the disclosure have been described in terms of various specific embodiments, those skilled in the art will recognize that the embodiments of the disclosure can be practiced with modifications within the spirit and scope of the claims.

What is claimed is:

1. A support bracket comprising:
a first support plate having a cut-out formed therein;
a second support plate extending from a top surface of the first support plate, the second support plate approximately perpendicular to the first support plate;
a second support plate connector opening formed through the second support plate; and
an “L” shape plate extending down from second support plate wherein a bottom leg of the “L” shape plate is approximately parallel with the second support plate.

2. A support bracket in accordance with claim 1 wherein the bottom leg of the “L” shape plate has a plurality of bottom leg connector holes.

3. A support bracket in accordance with claim 1 wherein the cut-out is a circular aperture formed in the first support plate.

4. A support bracket in accordance with claim 1 wherein the cut-out is a semi-circular aperture formed in a bottom edge of the first support plate.

5. A support bracket in accordance with claim 1 further comprising a plurality of first support plate connector holes formed around a perimeter of the first support plate.

6. A support bracket in accordance with claim 1 wherein the first support plate is “T” shaped.

7. A support bracket in accordance with claim 1 wherein the bottom leg of the “L” shaped plate is approximately planer with a top of the cut-out.

8. A support bracket comprising:
a first support plate;
a cut-out formed in the first support plate;
a second support plate extending from a top surface of the first support plate, the second support plate approximately perpendicular to the first support plate;
a second support plate connector opening formed through the second support plate;
an “L” shape plate extending down from second support plate wherein a bottom leg of the “L” shape plate is approximately parallel with the second support plate; and
a plurality of bottom leg connector holes formed in the bottom leg of the “L” shape plate;
wherein the bottom leg of the “L” shaped plate is approximately planer with a top of the cut-out.

9. A support bracket in accordance with claim 8 wherein the cut-out is a circular aperture formed in the first support plate.

10. A support bracket in accordance with claim 8 wherein the cut-out is a semi-circular aperture formed in a bottom edge of the first support plate.

11. A support bracket in accordance with claim 8 further comprising a plurality of first support plate connector holes formed around a perimeter of the first support plate.

12. A support bracket in accordance with claim 8 wherein the first support plate is “T” shaped.

13. A support bracket comprising:
a first support plate;
a cut-out formed in the first support plate for at least one of securing the first support plate to an electrical housing or for supporting an electrical conduit;
a second support plate extending from a top surface of the first support plate, the second support plate approximately perpendicular to the first support plate;
a second support plate connector opening formed through the second support plate for securing a first electrical support member placed around the electrical conduit to the second support plate;
an “L” shape plate extending down from second support plate wherein a bottom leg of the “L” shape plate is approximately parallel with the second support plate; and
a plurality of bottom leg connector holes formed in the bottom leg of the “L” shape plate for securing a second electrical support member placed around the electrical conduit to the “L” shape plate.

14. A support bracket in accordance with claim 13 wherein the cut-out is a circular aperture formed in the first support plate.

15. A support bracket in accordance with claim 13 wherein the cut-out is a semi-circular aperture formed in a bottom edge of the first support plate.

16. A support bracket in accordance with claim 13 further comprising a plurality of first support plate connector holes formed around a perimeter of the first support plate one of securing the first support plate to an electrical housing

17. A support bracket in accordance with claim 13 wherein the first support plate is “T” shaped.

18. A support bracket in accordance with claim 13 wherein the bottom leg of the “L” shaped plate is approximately planer with a top of the cut-out.
